(19) United States
(12) Patent Application Publication
(10) Pub. No.: US 2011/0020486 A1
(43) Pub. Date: Jan. 27, 2011

(54) DEVICE FOR FORMING FILM

(75) Inventor: Shao-Kai PEI, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/634,828

(22) Filed: Dec. 10, 2009

(30) Foreign Application Priority Data
Jul. 24, 2009 (CN) 200910304772.3

(51) Int. Cl. B29C 35/10

(52) U.S. Cl. 425/174.4

(57) ABSTRACT

A device for forming films on a substrate includes a main chamber and a reacting device. The main chamber is for receiving the substrate. The reacting device is received in the main chamber facing the substrate. The reacting device includes a reacting container, a supporting plate, a cover, and a collimation tube. The supporting plate and the cover are disposed on opposite ends of the reacting container to close the reacting container. The supporting plate is configured for supporting a target. The collimation tube is located in the reacting container to divide the reacting container into a first chamber and a second chamber. The target is located in the first chamber, and the cover defines a number of through holes.

### BACKGROUND

1. Technical Field

The disclosure relates to devices for forming film, and particularly, to a device for forming film on a substrate.

2. Description of Related Art

Generally, when a number of film layers are formed on a substrate by physical vapor deposition (PVD) and chemical vapor deposition (CVD), the substrate undergoes different process in different device to form different film layers. However, to remove a substrate from one device to another device such as from a device forming a CVD film layer to another device forming a PVD film layer is not only unduly time-consuming and inconvenient, but also affects the effect of film layers forming on the substrate.

Accordingly, it is desirable to provide a device for forming film on a substrate, which can overcome the above-mentioned problem.

### BRIEF DESCRIPTION OF THE DRAWINGS

FIG. 1 is a cross-sectional view of a device for forming film having a reacting device and a substrate according to an exemplary embodiment.

FIG. 2 is an isometric view of the reacting device shown in FIG. 1.

FIG. 3 is an exploded view of the reacting device shown in FIG. 2.

FIG. 4 is a cross-sectional view of the reacting device taken along the line IV-IV shown in FIG. 2.

### DETAILED DESCRIPTION

Embodiments of the disclosure will now be described in detail with reference to the accompanying drawings.

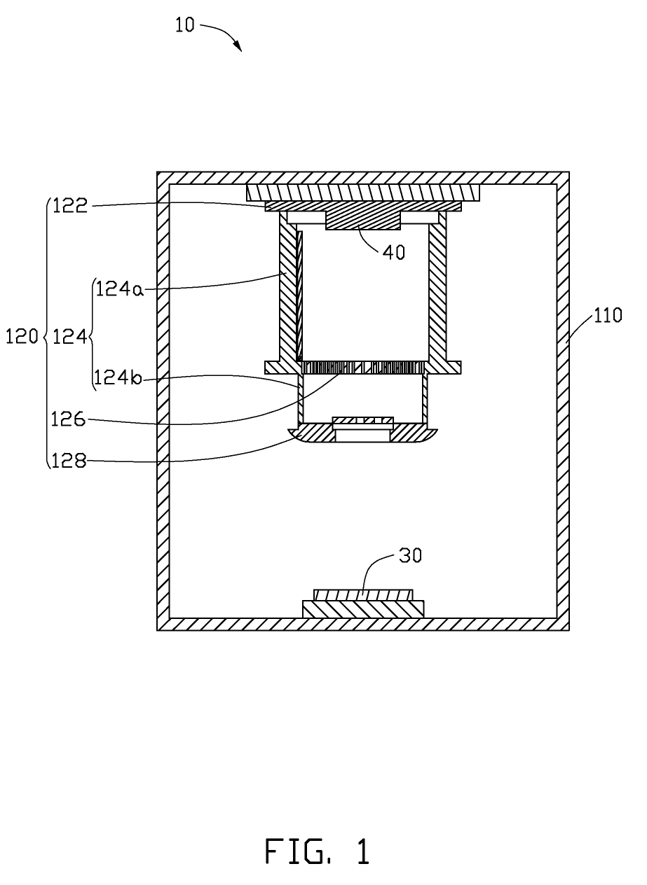

Referring to FIG. 1, a device 10 for forming films on a substrate 30 according to an exemplary embodiment is shown. The device 10 includes a main chamber 110 and a reacting device 120. The substrate 30 and the reacting device 120 are received in the main chamber 110, facing each other. In this embodiment, the substrate 30 is disposed on the bottom of the main chamber 110, and the reacting device 120 is disposed on the top of the main chamber 110.

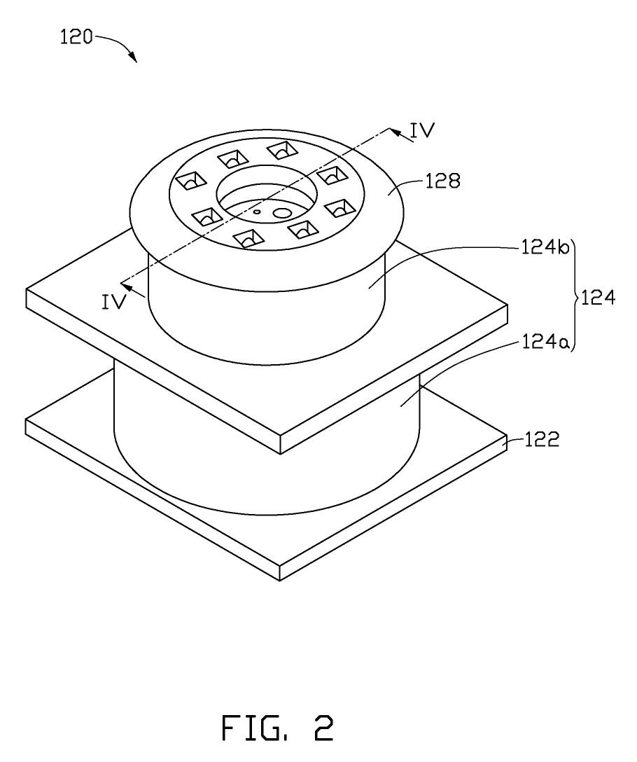

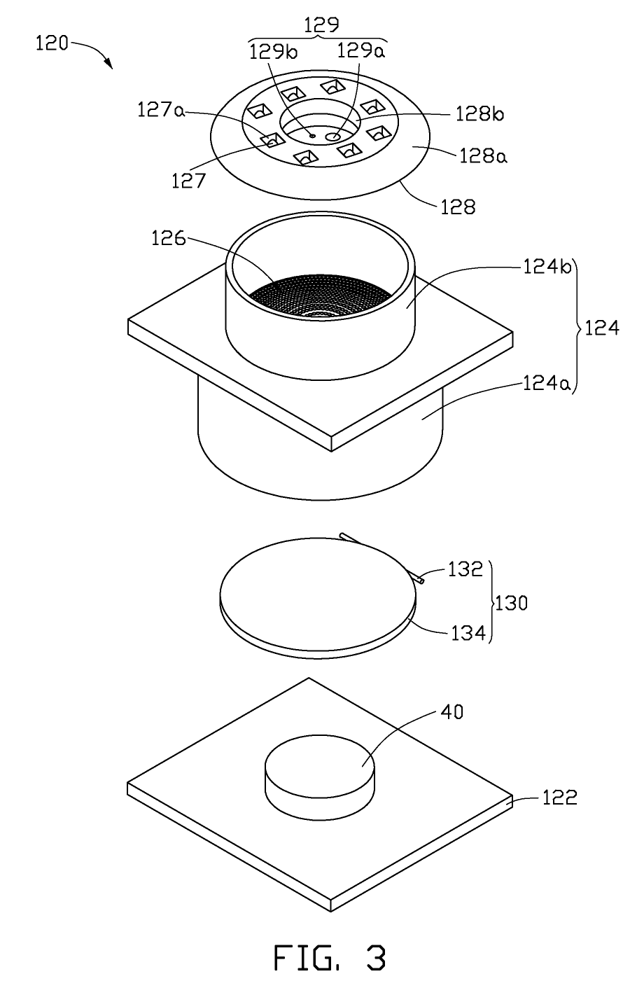

Referring to FIGS. 2-3, the reacting device 120 includes a supporting plate 122, a reacting container 124, a collimation tube 126, and a cover 128. The supporting plate 122 and the cover 128 are disposed on opposite ends of the reacting container 124 to close the reacting container 124. The collimation tube 126 is located in the reacting container 124 to divide the reacting container 124 into a first chamber 124a and a second chamber 124b. In this embodiment, the physical vapor deposition (PVD) process is performed in the first chamber 124a, and the chemical vapor deposition (CVD) process is performed in the second chamber 124a.

The supporting plate 122 is configured for supporting a target 40. The target 40 is located in the first chamber 124a. In this embodiment, the target 40 is made of titanium. A circular channel (not shown) is formed on two sides of the supporting plate 122 for providing cooling water to cool the supporting plate 122 and the target 40, to ensure that the film thickness formed on the substrate 30 is uniform. In this embodiment, the supporting plate 122 is made of stainless steel.

The reacting container 124 defines an inlet (not shown) for introducing reacting gas from exterior into the first chamber 124a. The reacting gas reacts with the target 40 in the first chamber 124a. The reacting gas is inert gas. In this embodiment, the reacting gas is argon.

The collimation tube 126 is configured for allowing target atoms vaporized from the target 40 to run from the first chamber 124a into the second chamber 124b. In this embodiment, the collimation tube 126 is made of titanium alloy.

The cover 128 includes a outer surface 128a. A groove 128b is defined in the outer surface 128a. A number of through holes 129 are defined in the bottom of the groove 128b and configured for communicating with exterior. In this embodiment, the through holes 129 include a number of outlets 129a and a number of inlets 129b. The outlet 129a is configured for allowing film materials to spurt onto the substrate 30, and the inlet 129b is configured for introducing gas from exterior to the second chamber 124b.

A power source (not shown) is connected both to the target 40 and the substrate 30, for example, a cathode of the power source is connected to the target 40 and an anode of the power source is connected to the substrate 30. To form layers on the substrate 30, firstly, argon is introduced into the first chamber 124a and the power source is turn on. The argon is ionized into argon ions (positive electricity) and argon electrons. The argon ions bombard the target 40 in an electric field created between the target 40 and the substrate 30, so that a number of target atoms are sputtered to complete the PVD process. Secondly, the target atoms run through the collimation tube 126 into the second chamber 124b. An oxygen gas is introduced into the second chamber 124b from the inlet 129b and reacts with the titanium atoms to generate titanium oxides, and the titanium oxides are spurted from the outlet 129a onto the substrate 30. A first film layer is formed on the substrate 30.

Subsequently, silicon tetrahydride and hydrogen are introduced into the second chamber 124b from the inlet 129b, to generate silicon film materials. The silicon film materials are spurted from the outlet 129a onto the substrate 30. A second film layer is formed on the substrate 30. It is to be understood, the device 10 can be configured for forming a number of film layers on the substrate 30, that is, different reacting materials such as tetrahydride and hydrogen are introduced from the inlet 129b to form a number of film layers such as silicon film materials according to requirement of users.

To prevent the film materials generated in the second chamber 124b from contaminating the target 40 in the first chamber 124a, the device 10 further includes a baffle assembly 130 to seal the first chamber 124a and the second chamber 124b.

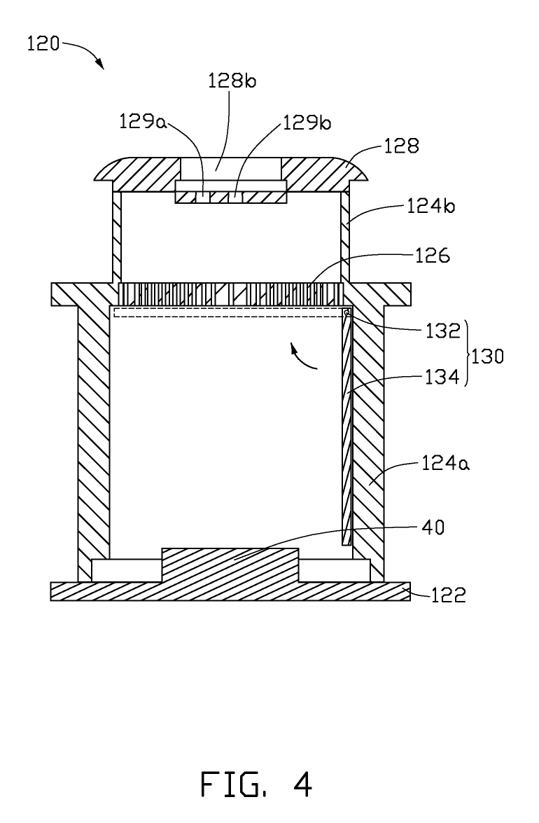

The baffle assembly 130 includes a shaft 132 and a baffle 134. The shaft 132 is disposed on a periphery of the baffle 134 and pivotally coupled to a sidewall of the first chamber 124a. A driver (not shown) is connected to the shaft 132 and configured for driving the shaft 132 to rotate the baffle 134. Referring to FIG. 4, before forming the first film layer, the baffle 134 is disposed under the collimation tube 126 to separate the first chamber 124a and the second chamber 124b. For forming an uniform film layer on the substrate 30, when target atoms are sputtered and the concentration of the target atoms becomes uniform in the second chamber 124b, the driver drives the shaft 132 to rotate the baffle 134 so that the baffle 134 to open the collimation tube 126, therefore the target atoms run through the collimation tube 126 into the second chamber 124b.

Subsequently, the driver drives the shaft 132 to rotate the baffle 134 to close the collimation tube 126, therefore the target 40 is not contaminated by the film materials generated in the second chamber 124b.

To allow the target atoms to completely react with the reacting materials introduced from the inlet 129b into the second chamber 124b, a number of ultraviolet lamps 127 are disposed on the cover 128. A number of receiving holes 127a are defined in the outer surface 128a of the cover 128 around the groove 128b for holding the ultraviolet lamps 127. The ultraviolet lamps 127 emit light to irradiate the second chamber 124b, to catalyze the reaction between the target atoms and the reacting materials.

It is to be understood, however, that even though numerous characteristics and advantages of the embodiments have been set forth in the foregoing description, together with details of the structures and functions of the embodiments, the disclosure is illustrative only, and changes may be made in detail, especially in matters of arrangement of parts within the principles of the invention to the full extent indicated by the broad general meaning of the terms in which the appended claims are expressed.

What is claimed is:

1. A device for forming films on a substrate, the device comprising:
a main chamber for receiving the substrate;
a reacting device received in the main chamber facing the substrate, the reacting device comprising:
a reacting container;
a supporting plate and a cover respectively disposed on opposite ends of the reacting container to close the reacting container, the supporting plate configured for supporting a target;
a collimation tube located in the reacting container to divide the reacting container into a first chamber and a second chamber;
wherein the target is located in the first chamber, and the cover defines a number of through holes.

2. The device of claim 1, wherein the cover comprises an outer surface, the outer surface defines a groove, the through holes are defined in the bottom of the groove.

3. The device of claim 1, wherein the cover comprises a number of ultraviolet lamps, the cover defines a number of receiving holes around the groove for holding the ultraviolet lamps, the ultraviolet lamps are configured for emitting light to irradiate the second chamber.

4. The device of claim 1, further comprising a baffle assembly configured for sealing the first chamber and the second chamber respectively.

5. The device of claim 4, wherein the baffle assembly is received in the first chamber and located between the collimation tube and the target.

6. The device of claim 5, wherein the baffle assembly comprises a shaft and a baffle, the shaft is disposed on a side of the baffle and pivotally coupled to a sidewall of the first chamber, the shaft capable of rotating to drive the baffle to rotate for sealing the first chamber and the second chamber.

7. The device of claim 1, wherein the collimation tube is made of titanium alloy.

8. The device of claim 1, wherein the supporting plate is made of stainless steel
